(19) United States
(12) Patent Application Publication
(10) Pub. No.: US 2008/0282903 A1
(43) Pub. Date: Nov. 20, 2008

(54) Tortilla warmer

(76) Inventor: Ricardo Gonzalez, Citrus Heights, CA (US)

Correspondence Address: CHRISTOPHER D. HARRINGTON, SUITE 350, 5300 CORPORATE GROVE DR SE, GRAND RAPIDS, MI, 49512, US

(21) Appl. No.: 11/803,774

(22) Filed: May 16, 2007

(51) Int. Cl. A47J 36/24

(52) U.S. Cl. 99/334

(57) ABSTRACT

A novel tortilla warmer is disclosed and comprises a housing with a feeder assembly, a feed system, a heating chamber and an output whereby unheated tortillas are individually fed into the tortilla warmer and are heated to a level selected by a user and outputted when ready. The tortilla warmer of the present invention can also employ a feeder assembly for the storage of unheated tortillas in a manner that is compatibly with automatic feeding of the tortillas into the tortilla warmer.

In one embodiment of the present invention, the tortilla warmer may be controlled by a remote control whereby the tortilla warmer functions can be activated from a distance.

### CROSS REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

The present invention relates to a device for warming tortillas. More particularly, the present invention relates to a device that automatically indexes individual tortillas and heats them to a desired temperature and then presents them for use.

Prepared tortillas have become an increasingly popular food item and can be found in virtually all major grocery stores across the United States. The tortilla itself has its origins in Pre-Columbian South America and was based on corn, or maize, that had been cured in lime water and then ground into flour and eventually working it into dough that could be pressed into flat, thin patties. These patties would then be cooked on a very hot terra cotta griddle called a comal resulting in light flat bread that has a unique taste and which serves as a foundation for many different recipes. Tortillas are also made from wheat flour, which was introduced from Spain, and are similarly handled as dough that is cooked as a flat unleavened bread. Surely people have their favorites when it comes to the type of tortilla, whether it is corn or wheat, stone ground or processed, thin or thick, but all agree that the tortilla is a unique and enjoyable food product that is served up in an endless number of ways.

Although the tortilla is very light and very tasty when it is warm, cold tortillas can be considered “rubbery” by some and certainly the taste of the tortilla is enhanced when it has been heated or when it is eaten right after it has been cooked. One of the problems in this regard is the fact that most tortillas that are consumed are prepared products that are purchase off the grocery shelves. It is too time consuming for most people to use traditional methods for making tortillas and the compromise is made for the sake of convenience to purchase the prepared product instead. The prepared tortillas are typically offered on the grocery shelf like other bread products. Inasmuch as they are at room temperature, they do not have the maximum taste appeal that a cooked or warmed tortilla has normally. This may be cured in some cases where the consumer uses the tortilla in a recipe that is baked, but in other circumstances where the tortilla is to be used for a hand-held food many people find that they need to take the extra step to heat the tortilla in an oven or similar in order to maximize its flavor and texture.

There have been efforts in the prior art to provide a way to heat tortillas when they are ready to be used. For instance, in U.S. Pat. No. 6,268,592 (Hu, et al) a tortilla grill is disclosed with a heated griddle like surface for grilling the tortilla and with a warming compartment for holding warmed tortillas. The Hu grill does take time and requires the attention of the user to make sure the tortilla is not overly cooked. Plus it does require some time for the grill to warm up and as is known to be the case in many types of griddle surfaces, uneven heating can occur leading to tortillas that are not consistently cooked.

In U.S. Pat. No. 4,013,869 (Orts) a device for warming and hydrating previously prepared tortillas is shown as comprising a warming base, a kettle with a lid and a rack for holding the tortillas above the floor of the kettle so that a small quantity of water can be added before using. Orts does not provide a device that will heat tortillas individually or necessarily in a uniform fashion. In addition, Orts does require a great deal of preparation for use which is an inhibiting factor for consumers who desire to have their tortilla warmed up quickly for use. In U.S. Pat. No. 4,782,745 (George, Jr.) is similar to the Orts invention although it is used as an independent assembly that can be heated over a burner. George also has two tiers of racks for holding the tortillas which only marginally improves the distribution of heating through the tortillas.

In U.S. Pat. No. 5,765,471 (Monard) the long felt need for a tortilla warmer that can uniformly heat individual tortillas is discussed. The solution of Monard is to provide a series of vertically aligned racks that hold individual tortillas in place between heating elements. Unlike the present invention though, Monard requires the user to insert each tortilla in place and to remove them when done. Aside from the convenience in having multiple heating facilities for tortillas, Monard does not really advance the art with a solution for heating tortillas in an easy and convenient manner. The cooker in U.S. Pat. No. 5,535,664 (Rokowski) teaches a cooking device that has a series of stackable “cookers” or trays that allow individual items to be cooked. In addition, the device can be remotely activated by telephone. Like Monard, the Rokowski device requires manual input for each item to be cooked. In addition, the remote control aspects of the Rokowski device are very specific to the use of a telephone based signal.

Lastly, the tortilla warmer disclosed in U.S. Design Pat. No. Des. 305,197 (Valdes) which appears to be of the type that collectively heats a number of tortillas all at once and does not teach the method of heating tortillas as found in the present invention.

The need for a tortilla warmer that can easily heat individual tortillas on demand has been a longstanding need and has not been satisfied through the prior art. The tortilla is best when heated on both sides to the desired level of cooking. This uniformity has been frustrated when attempting to process tortillas in batches since there is the problem that not all will be heated to the same degree, some will become desiccated, and if they are touching one another, then some may actually end up sticking and being wasted.

These problems have been resolved with the advent of the present invention.

### SUMMARY OF THE INVENTION

A novel warmer for tortillas comprises a housing with a feeder assembly, a feeder roller, a heating element, a tray, a tray roller, and an output, where the feeder assembly is capable of feeding tortillas individually into the feeder roller. The feeder roller transfers the tortillas into a heating chamber where they reside for a selected period of time and heated to the desired level, and from there the tortillas are transferred by the tray roller through the output. The tortillas exit from the warmer individually where they can be collected for consumption by the user.

### BRIEF DESCRIPTION OF THE DRAWINGS

FIG. 1 is an isometric view of a tortilla warmer of the present invention.

FIG. 2 is a side cross sectional view of the tortilla warmer of FIG. 1 taken along Section Lines 2-2

FIG. 3 is a top view of the tortilla warmer of FIG. 1.

FIG. 4 is an isometric view of a remote control for use with the tortilla warmer of the present invention.

### DETAILED DESCRIPTION OF THE PREFERRED EMBODIMENTS

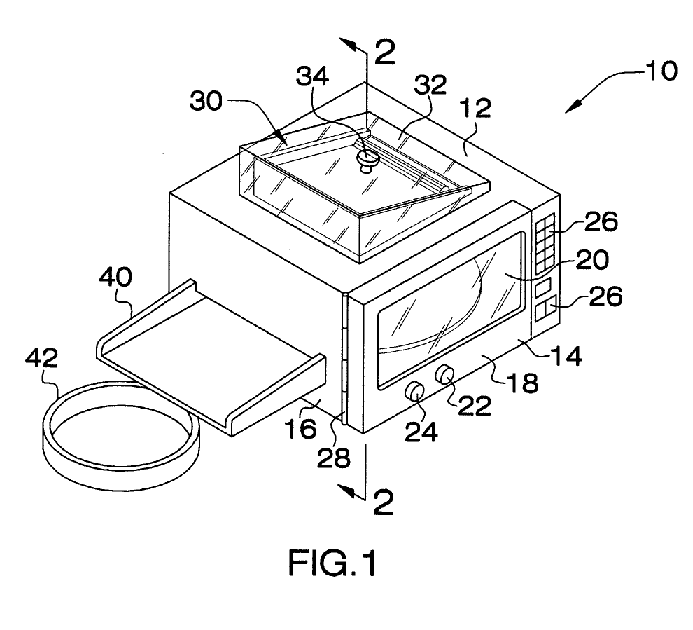

A tortilla warmer in accordance with the present invention is shown in the drawings and is described in detail herein. As seen in FIG. 1, a tortilla warmer 10 includes a top 12, a front 14, an output side 16, a door 18, a window 20, a timer 22, an on/off switch 24, and a control panel 26. The door 18 includes a door hinge 28. On the top 12 is the feeder assembly 30 which includes the feeder top 32 and the knob 34. The output side 16 has the output tray 40 and the dish 42.

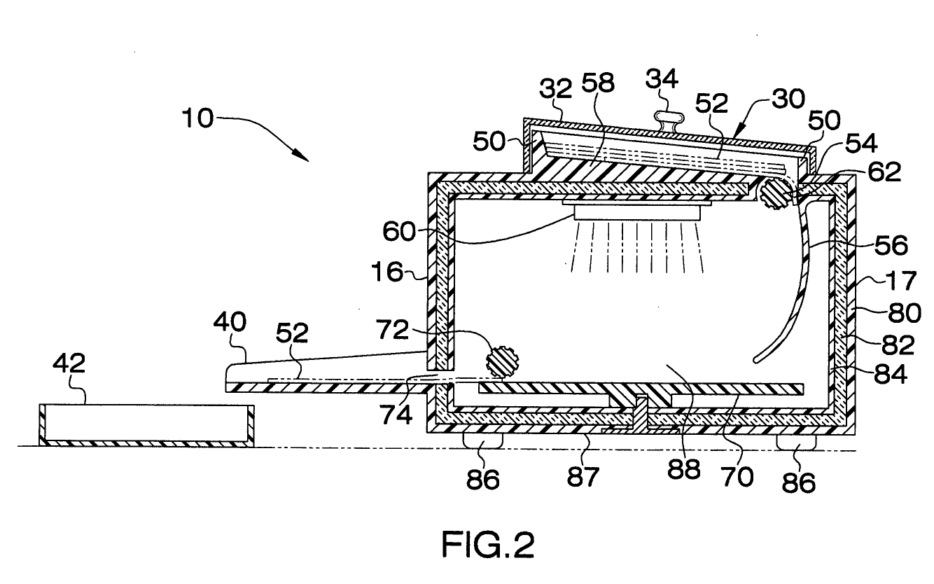

In FIG. 2, interior portions of the tortillas warmer 10 can be seen, including the feeder mounts 50, the tortillas 52 in condition to be fed into the feeder roller 54 through the feeder opening 62, and thereafter into the feeder guide 56. The heating chamber 88 includes the heater element 60, the heater tray 70 and the tray roller 72. The output opening 74 is aligned to allow the tortillas to exit the heating chamber 88. Also viewable is the housing sidewall 17 and the housing bottom 87.

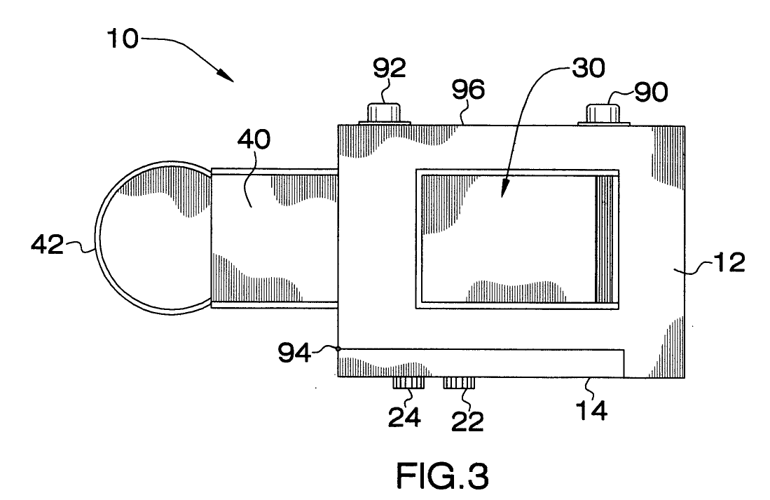

The housing 80 encloses the heating chamber 88 and other interior components of the tortilla warmer 10, including the insulation layer 82, the inner walls 84 and the feet 86 which are attached to the outside of the housing 80. As viewed in FIG. 3, the upper feeder drive 90 and the feeder roller drive 92 can be seen on the rear side 96 of the tortilla warmer 10. Also viewable is the door hinge 94.

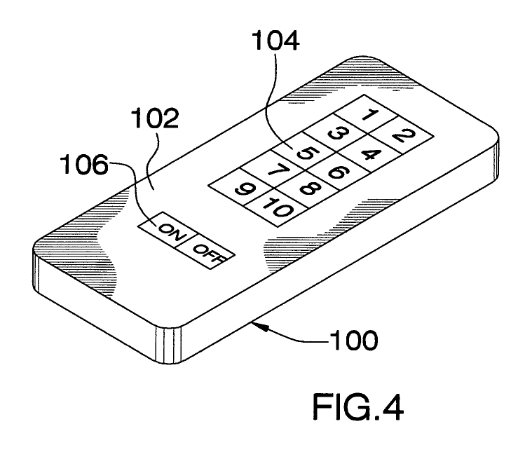

A remote control 100 is shown in FIG. 4 for use in conjunction with the tortilla warmer 10 of the present invention. The remote control 100 includes a housing 102, a keypad 104 and an on/off switch 106.

Normally, the tortilla warmer will sit idle until its use is desired by the consumer. When needed, the feeder assembly can be loaded (or it may already have been loaded) with tortillas that are to be warmed. The feeder assembly can be movable between the top of the tortilla warmer and a storage place such as a refrigerator or cupboard. The feeder assembly fits onto the feeder mounts which not only help retain the feeder assembly onto the tortilla warmer but keep the feeder assembly aligned with the feeder roller and the feeder opening. The size, and accordingly the capacity, of the feeder assembly can be adjusted to match the consumer's preferences so that larger amounts of tortillas (or lesser) can be readied for feeding into the tortilla warmer. The tortillas are laid inside the feeder assembly by opening the feeder assembly top and laying them as shown in FIG. 2. The tortilla warmer may require a warm-up time to reach its operating temperatures depending on the type of heating element employed. Nonetheless, once the tortilla warmer is ready, each tortilla is fed individually into the heating chamber by gravity and then by the feeder roller. The tortilla is fed into the feeder opening and then is guided by the feeder guide where it lands on the tray and is held there while it is heated by the heating element. The heating time is determined by a control mechanism which is controlled by the keypad and/or the remote control. The heating time is calculated to be the optimal time for bringing the tortilla up to the desired level before it is discharged from the heating chamber. This calculation takes into account the amount of heat supplied by the heating element and preferentially the time allotted can be adjusted by the user to match his/her preferences.

The heating element may be a traditional electrical resistance type element where the heat comes from applying an electrical current to a steel coil or similar. The heating element may also be a microwave source or an infrared source. Any heating element that satisfies the basic requirements for heating the tortilla within a time frame that is acceptable to the user would be considered for use in the present invention. The objective would be to supply a uniform level of heat to the tortilla causing the tortilla to be heated evenly and thoroughly. While this function is partly time-based, the heating element can be scaled appropriately to match the time frame that the tortilla is resident within the heating chamber.

Once the tortilla is sufficiently heated, the tray roller is activated and causes the tortilla to be ejected through the output opening where it is directed by the output tray into a receptacle chosen by the user. This may be a plate or as shown in the drawings a dish that is shaped liked the tortilla and sized to hold a stack of tortillas. Once the tortilla has been ejected, the next tortilla to be heated is indexed and fed into the feeder roller and the process is repeated. The controls can be set to process as many or as few of the tortillas as the user selects. The temperature settings, as alluded to above, can be adjusted to suit the user's preferences as well. The controls can all be reduced to digital inputs as would be effectuated by one skilled in the art. This would reduce the number of controls for the tortilla warmer since all information could be inputted through the control panel. The tortilla warmer of the present invention includes a door that is hinged to be opened from one side. This allows the user to clear the heating chamber of any tortillas that may become stuck in place and also for access to clean the interior of the unit as well.

The rollers as shown in the preferred embodiment, extend across the depth of the heating chamber and are driven using drive motors that are installed on the rear of the housing. This comprises the feed system for the preferred embodiment. The rollers are designed to be able to grip the tortillas and as the rollers rotate, they will urge the tortilla into the path described above for the heating process. The rollers can be driven in synchronization with the controls for the tortilla warmer which will cause one tortilla to be fed through the system at a time. Thus the rollers will operate as needed, with the feeder roller introducing the tortilla into the heating chamber and the tray roller activating to output the tortilla when the heating process has been completed.

One aspect to the present invention arises from the use of a remote control. In a busy household, the kitchen can become a place of mass contusion and the ability to control the tortillas warmer from a distance would be of great benefit at times. The user could activate the tortilla warmer and adjust it for all of the conditions that would normally apply if the user were using the control panel. This frees the user to continue working on other parts of the meal preparation without having to actually attend to the tortilla warmer. In addition, if the user is disabled and has difficulty reaching the control panel or has similar restrictions, then the remote control offers a way for this person to activate the tortilla warmer and maintain some level of independence.

Variations on the tortilla warmer of the present invention may be made without departing from the teachings herein. For instance, the tortilla warmer could be constructed without the door as offered in the preferred embodiment. Other types of feed mechanisms may be employed other than rollers, such as a belt system for example, without really altering the core functionality of the present invention. The height of the output tray can be varied to allow more tortillas to be stacked in the dish. This can be accomplished by mere adjustment of the output tray, or the height of the warmer could adjusted in total. In addition, the output tray and the dish could be formed as a single construction. In some instances it may be possible to construct a tortilla warmer where the tortillas can be fed into a heating chamber on a continuous basis without having to halt the tortilla and wait until it reaches the desired temperature. This would be a matter of adjusting the heating element and feed systems accordingly, although for the present invention it is believed that the method for heating as described would result in a more uniform result. Other variations can be made in the way the tortillas are handled (they could be hand fed) or in the number and/or orientation of the components of the preferred embodiment although these would be viewed as part of the present invention.

I claim:

1. A tortilla warmer for warming tortillas, the tortilla warmer comprising:
A housing with a front, a top, sides and a bottom;
A heating chamber enclosed within said housing where the heating chamber includes a heating element that is adjustably operable to heat tortillas;
A feed system for automatically feeding individual tortillas into the housing and into the heating chamber;
An output system for removing individual tortillas from the heating chamber and discharging them outside the housing; and,
A control system for operably commencing the feeding of the individual tortillas into the heating chamber and discharging same and under conditions selected by the user.

2. The tortilla warmer of claim Number 1, where the feed system further includes a feeder assembly for the storage of unheated tortillas and where the feeder assembly is operably compatible with the feed system for the feeding of individual tortillas into the tortilla warmer for heating.

3. The tortilla warmer of claim Number 1, where the tortilla warmer includes a remote control for remote operation of the tortilla warmer.

4. The tortilla warmer of claim Number 1, where the heating element is of the electrical resistance type of heating element.

5. The tortilla warmer of claim Number 1, where the heating element is of the microwave type of heating element.

6. The tortilla warmer of claim Number 1, where the heating element is of the infrared type of heating element.

7. A tortilla warmer for warming tortillas, the tortilla warmer comprising:
A housing with a front, a top, sides and a bottom;
A heating chamber enclosed within said housing where the heating chamber includes a heating element that is adjustably operable to heat tortillas;
A feed system for automatically feeding individual tortillas into the housing and into the heating chamber where the feed system further includes a feeder assembly for the storage of unheated tortillas and where the feeder assembly is operably compatible with the feed system for the feeding of individual tortillas into the tortilla warmer for heating;
An output system for removing individual tortillas from the heating chamber and discharging them outside the housing; and,
A control system for operably commencing the feeding of the individual tortillas into the heating chamber and discharging same and under conditions selected by the user.

8. The tortilla warmer of claim Number 7, where the tortilla warmer includes a remote control for remote operation of the tortilla warmer.

9. The tortilla warmer of claim Number 7, where the heating element is of the electrical resistance type of heating element.

10. The tortilla warmer of claim Number 7, where the heating element is of the microwave type of heating element.

11. The tortilla warmer of claim Number 7, where the heating element is of the infrared type of heating element.

12. A tortilla warmer for warming tortillas, the tortilla warmer comprising:
A housing with a front, a top, sides and a bottom;
A heating chamber enclosed within said housing where the heating chamber includes a heating element that is adjustably operable to heat tortillas, where the heating element is of the electrical resistance type;
A feed system for automatically feeding individual tortillas into the housing and into the heating chamber where the feed system further includes a feeder assembly for the storage of unheated tortillas and where the feeder assembly is operably compatible with the feed system for the feeding of individual tortillas into the tortilla warmer for heating;
An output system for removing individual tortillas from the heating chamber and discharging them outside the housing;
An output tray for directing the heated tortillas into a dish for storage of the heated tortillas; and,
A control system for operably commencing the feeding of the individual tortillas into the heating chamber and discharging same and under conditions selected by the user.

13. The tortilla warmer of claim Number 12, where the tortilla warmer includes a remote control for remote operation of the tortilla warmer.

14. The tortilla warmer of claim Number 12, where the housing is insulated.
